(19) United States
(12) Patent Application Publication
(10) Pub. No.: US 2014/0043327 A1
(43) Pub. Date: Feb. 13, 2014

(54) METHOD AND SYSTEM FOR SUPERIMPOSING CONTENT TO HAVE A FIXED POSE

(71) Applicant: Texas Instruments Incorporated, Dallas, TX (US)

(72) Inventor: Vinay Sharma, Dallas, TX (US)

(73) Assignee: Texas Instruments Incorporated, Dallas, TX (US)

(21) Appl. No.: 13/965,843

(22) Filed: Aug. 13, 2013

Related U.S. Application Data
(60) Provisional application No. 61/682,441, filed on Aug. 13, 2012.

(51) Int. Cl. G06T 15/00

(52) U.S. Cl. CPC G06T 15/00
USPC 345/419

(57) ABSTRACT

A first camera captures first images of first views. A display device displays the first images on a screen of the display device. A second camera captures second images of second views. Visual features are detected and tracked in the second images. A pose is estimated of the second camera in response to the tracked visual features. On the first images on the screen, content is superimposed to have a fixed pose in response to the estimated pose of the second camera.

### CROSS-REFERENCE TO RELATED APPLICATION

This application claims priority to U.S. Provisional Patent Application Ser. No. 61/682,441, filed Aug. 13, 2012, entitled METHOD AND APPARATUS FOR AUGMENTING A SURFACE USING CAMERA VIEWS, naming Vinay Sharma as inventor.

This application is related to co-owned co-pending: (a) U.S. patent application Ser. No. ______, (Docket No. TI-72450), filed on even date herewith, entitled METHOD AND SYSTEM FOR DISPLAYING CONTENT TO HAVE A FIXED POSE, naming Vinay Sharma as inventor; and (b) U.S. patent application Ser. No. ______, (Docket No. TI-74144), filed on even date herewith, entitled METHOD AND SYSTEM FOR PROJECTING CONTENT TO HAVE A FIXED POSE, naming Vinay Sharma as inventor.

All of the above-identified applications are hereby fully incorporated herein by reference for all purposes.

### BACKGROUND

The disclosures herein relate in general to image processing, and in particular to a method and system for superimposing content to have a fixed pose.

If an information handling system can determine how its pose changes in relation to a fixed world x-y-z coordinate frame, then the system can display content to have a fixed pose in such coordinate frame. For example, to help the system determine how its pose changes, the system may perform a computer vision operation for detecting and tracking visual features in images that are captured by a camera of the system. However, such detection and tracking may be unreliable if sufficient visual features are missing from surface(s) in the camera's field of view.

### SUMMARY

A first camera captures first images of first views. A display device displays the first images on a screen of the display device. A second camera captures second images of second views. Visual features are detected and tracked in the second images. A pose is estimated of the second camera in response to the tracked visual features. On the first images on the screen, content is superimposed to have a fixed pose in response to the estimated pose of the second camera.

### BRIEF DESCRIPTION OF THE DRAWINGS

FIG. 1 is a first perspective view of a mobile smartphone that includes an information handling system of the illustrative embodiments.

FIG. 2 is a second perspective view of the system of FIG. 1.

FIG. 3 is a block diagram of the system of FIG. 1.

FIG. 4 is a first example image that is displayed by a display device of FIG. 3.

FIG. 5 is a second example image that is displayed by the display device of FIG. 3.

FIG. 6 is a third example image that is displayed by the display device of FIG. 3.

FIG. 7 is a flowchart of an operation of the system of FIG. 1.

### DETAILED DESCRIPTION

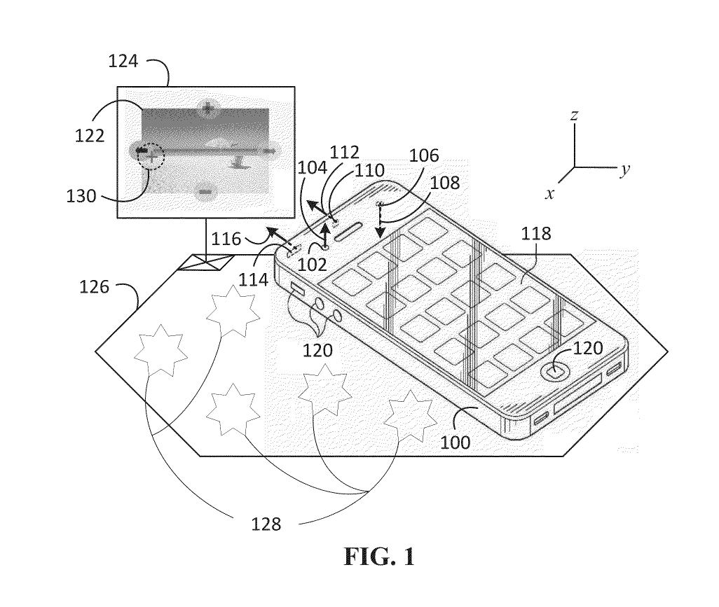

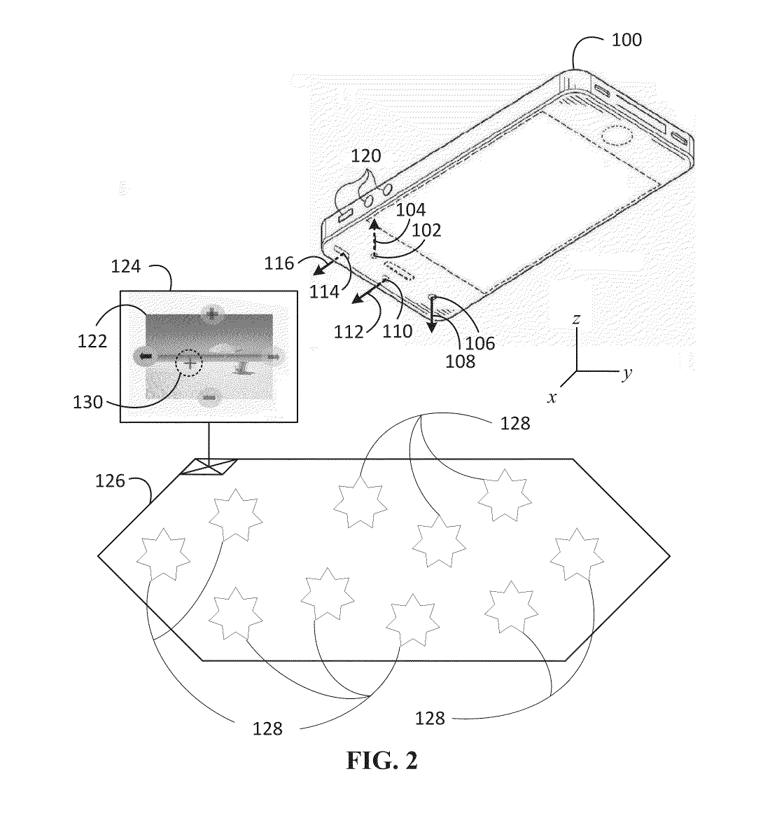

FIG. 1 is a first perspective view of a mobile smartphone that includes an information handling system 100 of the illustrative embodiments. FIG. 2 is a second perspective view of the system 100. In this example, as shown in FIGS. 1 and 2, the system 100 includes: (a) on a front of the system 100, a front-facing camera 102 that points in a direction of an arrow 104; (b) on a back of the system 100, a rear-facing camera 106 that points in a direction of an arrow 108 (substantially opposite the direction of the arrow 104); and (c) on a top of the system 100, a top-facing camera 110 that points in a direction of an arrow 112 (substantially orthogonal to the directions of the arrows 104 and 108), and a projector 114 that points in a direction of an arrow 116 (substantially parallel to the direction of the arrow 112).

Also, the system 100 includes a touchscreen 118 (on the front of the system 100) and various switches 120 for manually controlling operations of the system 100. In the illustrative embodiments, the various components of the system 100 are housed integrally with one another. Accordingly, respective directions of the arrows 104, 108, 112 and 116 are fixed in relation to the system 100 and one another.

A pose of the system 100 is described by: (a) a rotation matrix R, which describes how the system 100 is rotated with three (3) degrees of freedom in a fixed world x-y-z coordinate frame; and (b) a translation vector t, which describes how the system 100 is translated with three (3) degrees of freedom in such coordinate frame. Accordingly, the pose of the system 100 has a total of six (6) degrees of freedom in such coordinate frame. Similarly, an image 122 and surfaces 124 and 126 have respective poses, each with a total of six (6) degrees of freedom in such coordinate frame.

The surface 126 (e.g., ground) is non-overlapping with the surface 124 and has a fixed pose in relation to the surface 124 (e.g., wall or projection screen). Also, the surface 126 has visual features 128 (e.g., texture) as shown in FIG. 1. In one example, the features 128 have better sufficiency than features on other surfaces (e.g., the surface 124), because the features 128 have sufficient detectability and/or trackability (e.g., sufficient visibility and/or numerosity), unlike features on those other surfaces.

In the illustrative embodiments, the projector 114 is a light projector (e.g., pico projector) that is suitable for projecting the image 122 onto the surface 124, under control of the system 100. Also, under control of the system 100, the projector 114 is suitable for projecting additional digital content for superimposition on the image 122. In the example of FIGS. 1 and 2, such content includes a “+” button, a “−” button, a “←” button and a “→” button (collectively “control buttons”), which are superimposed on the image 122. Accordingly, the projector 114 is a type of display device for displaying the image 122 and/or such additional digital content by projection thereof onto the surface 124.

In a first mode of operation, under control of the system 100, the projector 114 projects the image 122 and the control buttons to have a fixed pose on the surface 124, even if the pose of the system 100 changes (within a particular range) in relation to the surface 124. For example, in comparison to the pose of the system 100 in FIG. 1, the pose of the system 100 in FIG. 2 has changed. Despite such change, under control of the system 100, the projector 114 projects the image 122 and the control buttons to have their fixed pose on the surface 124, as shown in FIGS. 1 and 2.

Moreover, in the first mode of operation, under control of the system 100, the projector 114 is suitable for projecting a cursor 130 (which is additional digital content) to have a variable pose. As shown in FIGS. 1 and 2, the pose of the cursor 130 varies in response to change in the pose of the system 100, so that the cursor 130 is located along a line of the arrow 116. Accordingly, if the line of the arrow 116 intersects the image 122, then the cursor 130 is superimposed on the image 122.

In that manner, a human user is able to change the pose of the system 100 and thereby point the arrow 116 at a control button, so that the cursor 130 is superimposed on such control button (e.g., as shown in FIG. 1). In response to the user activating a suitable one of the switches 120 while the cursor 130 is superimposed on a control button, the system 100 causes the projector 114 to change the pose of the image 122, such as: (a) rotating the image 122 up if the cursor 130 is superimposed on the “+” button; (b) rotating the image 122 down if the cursor 130 is superimposed on the “−” button; (c) rotating the image 122 left if the cursor 130 is superimposed on the “←” button; and (d) rotating the image 122 right if the cursor 130 is superimposed on the “→” button.

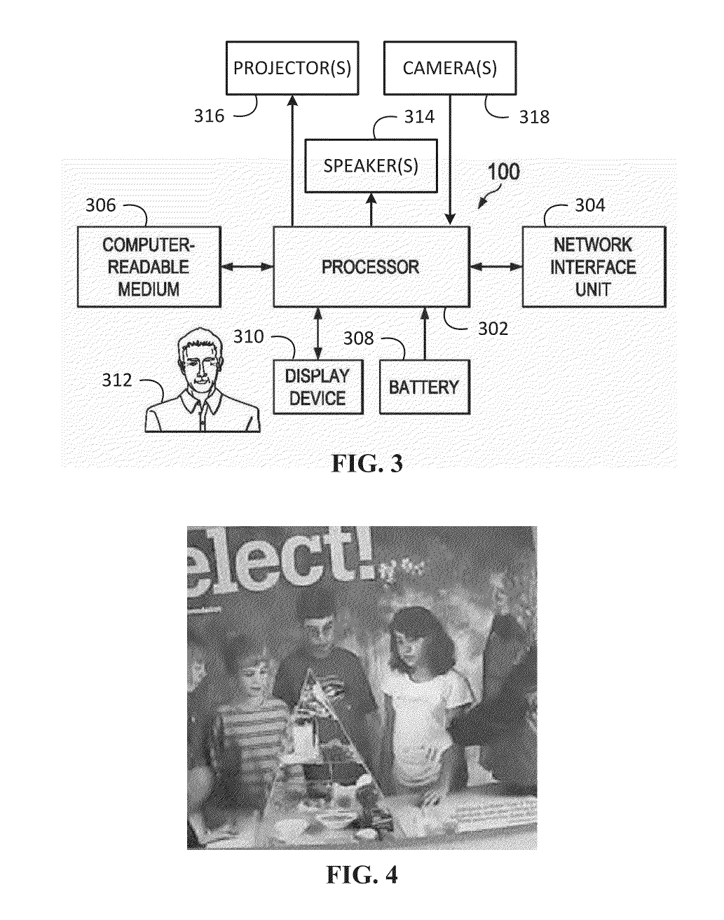

FIG. 3 is a block diagram of the system 100. The system 100 includes various electronic circuitry components for performing the system 100 operations, implemented in a suitable combination of software, firmware and hardware. Such components include: (a) a processor 302 (e.g., one or more microprocessors and/or digital signal processors), which is a general purpose computational resource for executing instructions of computer-readable software programs to process data (e.g., a database of information) and perform additional operations (e.g., communicating information) in response thereto; (b) a network interface unit 304 for communicating information to and from a network in response to signals from the processor 302; (c) a computer-readable medium 306, such as a nonvolatile storage device and/or a random access memory (“RAM”) device, for storing those programs and other information; (d) a battery 308, which is a source of power for the system 100; (e) a display device 310 that includes a screen for displaying information to a human user 312 and for receiving information from the user 312 in response to signals from the processor 302; (f) speaker(s) 314 for outputting sound waves (at least some of which are audible to the user 312) in response to signals from the processor 302; (g) projector(s) 316, such as the projector 114; (h) camera(s) 318, such as the cameras 102, 106 and 110; and (i) other electronic circuitry for performing additional operations. In the illustrative embodiments, the various electronic circuitry components of the system 100 are housed integrally with one another.

As shown in FIG. 3, the processor 302 is connected to the computer-readable medium 306, the battery 308, the display device 310, the speaker(s) 314, the projector(s) 316 and the camera(s) 318. For clarity, although FIG. 3 shows the battery 308 connected to only the processor 302, the battery 308 is further coupled to various other components of the system 100. Also, the processor 302 is coupled through the network interface unit 304 to the network (not shown in FIG. 3), such as a Transport Control Protocol/Internet Protocol (“TCP/IP”) network (e.g., the Internet or an intranet). For example, the network interface unit 304 communicates information by outputting information to, and receiving information from, the processor 302 and the network, such as by transferring information (e.g. instructions, data, signals) between the processor 302 and the network (e.g., wirelessly or through a USB interface).

The system 100 operates in association with the user 312. In response to signals from the processor 302, the screen of the display device 310 displays visual images, which represent information, so that the user 312 is thereby enabled to view the visual images on the screen of the display device 310. In one embodiment, the display device 310 is a touchscreen (e.g., the touchscreen 118), such as: (a) a liquid crystal display (“LCD”) device; and (b) touch-sensitive circuitry of such LCD device, so that the touch-sensitive circuitry is integral with such LCD device. Accordingly, the user 312 operates the touchscreen (e.g., virtual keys thereof, such as a virtual keyboard and/or virtual keypad) for specifying information (e.g., alphanumeric text information) to the processor 302, which receives such information from the touchscreen.

For example, the touchscreen: (a) detects presence and location of a physical touch (e.g., by a finger of the user 312, and/or by a passive stylus object) within a display area of the touchscreen; and (b) in response thereto, outputs signals (indicative of such detected presence and location) to the processor 302. In that manner, the user 312 can touch (e.g., single tap and/or double tap) the touchscreen to: (a) select a portion (e.g., region) of a visual image that is then-currently displayed by the touchscreen; and/or (b) cause the touchscreen to output various information to the processor 302.

In a first embodiment, the display device 310 is housed integrally with the various other components of the system 100, so that a pose of the display device 310 is fixed in relation to such other components. In a second embodiment, the display device 310 is housed separately from the various other components of the system 100, so that a pose of the display device 310 is variable in relation to such other components. In one example of the second embodiment, the display device 310 has a fixed pose in the fixed world x-y-z coordinate frame, while such other components (e.g., the projector(s) 316 and the camera(s) 318) have a variable pose in the fixed world x-y-z coordinate frame.

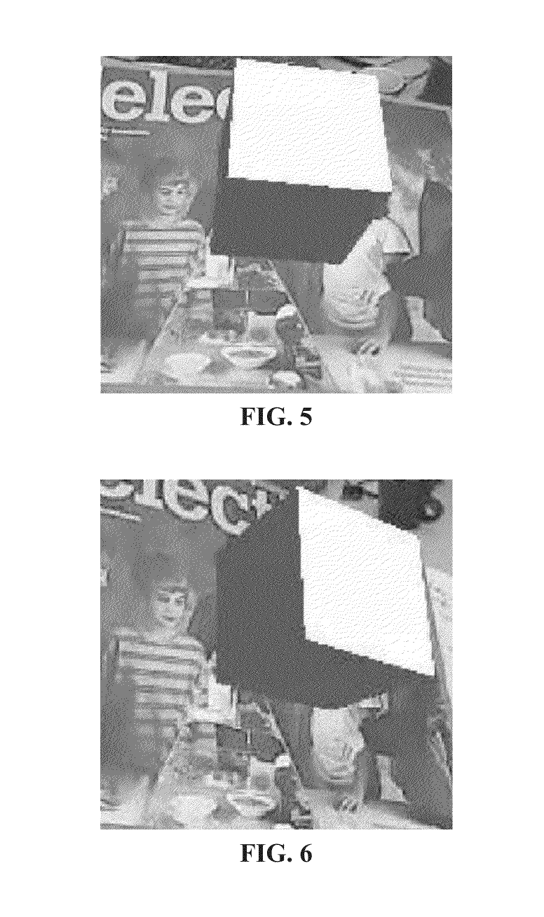

FIG. 4 is a first example image that is displayed by the display device 310. FIG. 5 is a second example image that is displayed by the display device 310. FIG. 6 is a third example image that is displayed by the display device 310.

In response to processing (e.g., executing) instructions of a software program, and in response to information (e.g., commands) received from the user 312 (e.g., via the touchscreen 118 and/or the switches 120), the processor 302 causes a selected one of the camera(s) 318 (e.g., the camera 106) to: (a) view a scene (e.g., including a physical object and its surrounding foreground and background); (b) capture and digitize images of such views; and (c) outputs such digitized (or “digital”) images to the processor 302, such as a video sequence of those images. The processor 302 causes the screen of the display device 310 to display one or more of those images, such as the image of FIG. 4.

In the example of FIGS. 5 and 6, in response to processing instructions of the software program, and in response to information received from the user 312, the processor 302 causes the screen of the display device 310 to superimpose additional digital content on those images. As shown in FIGS. 5 and 6, the additional digital content has a cube shape, which the processor 302 causes the screen of the display device 310 to superimpose on the image.

In a second mode of operation, under control of the processor 302, the screen of the display device 310 superimposes such content on the image, so that such content appears to have a fixed pose in the fixed world x-y-z coordinate frame, even if the pose of the system 100 changes (within a particular range) in relation to such coordinate frame. For example, in comparison to the pose of the system 100 in FIG. 5 (as evident from viewing of the scene by the selected one of the camera(s) 318), the pose of the system 100 in FIG. 6 has changed. Despite such change, under control of the processor 302, the screen of the display device 310 superimposes such content on the image, so that such content appears to have its fixed pose in such coordinate frame, as shown in FIGS. 5 and 6.

As discussed hereinabove in connection with FIGS. 1 and 2, respective directions of the arrows 104, 108, 112 and 116 are fixed in relation to the system 100 and one another. To help the system 100 determine how its pose changes in relation to the fixed world x-y-z coordinate frame, the processor 302 performs a computer vision operation for detecting and tracking visual features in images that are captured by one or more of the camera(s) 318. The processor 302 performs such detection and tracking in a substantially real-time manner, in response to live images that the processor 302 receives from such camera(s) 318. Accordingly, the processor 302 determines how its pose changes by detecting and tracking visual features in one or more fields of view of such camera(s) 318.

In the example of FIGS. 1 and 2, if the system 100 determines how its pose changes by detecting and tracking visual features in the field of view of only the camera 102, then such detection and tracking may be unreliable if sufficient visual features are missing from surface(s) in such field of view. Likewise, if the system 100 determines how its pose changes by detecting and tracking visual features in the field of view of only the camera 110, then such detection and tracking may be unreliable if sufficient visual features are missing from surface(s) in such field of view. Similarly, in the example of FIGS. 5 and 6, if those images are captured by the camera 106, and if the system 100 determines how its pose changes by detecting and tracking visual features in the field of view of only the camera 106, then such detection and tracking may be unreliable if sufficient visual features are missing from surface(s) in such field of view.

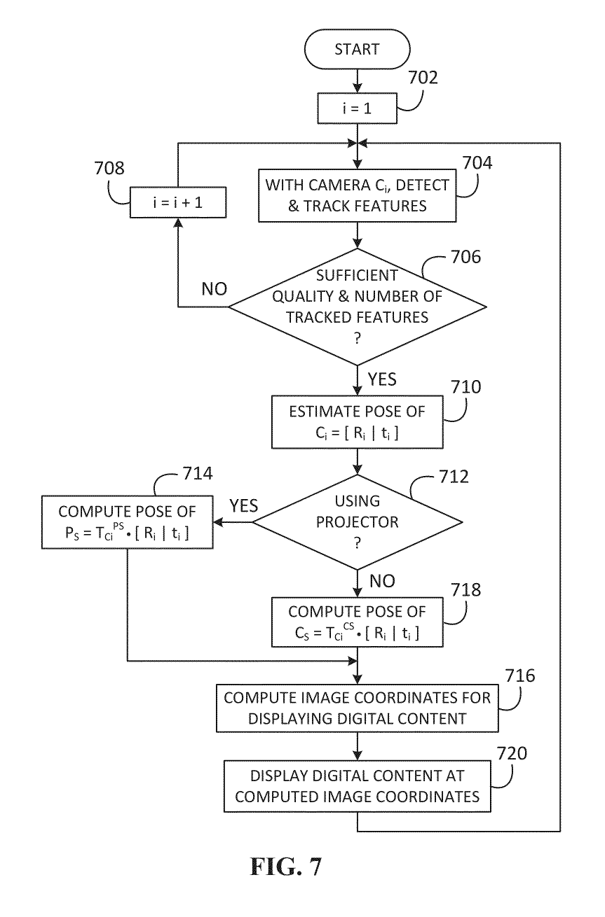

FIG. 7 is a flowchart of an operation of the system 100 for determining how its pose changes by detecting and tracking visual features in images that are captured by one or more of the camera(s) 318, which are denoted as Cₖ, where k is a positive integer from 1 through n, and where n is a total number of the camera(s) 318. Similarly, the projector(s) 316 are denoted as Pⱼ, where j is a positive integer from 1 through m, and where m is a total number of the projector(s) 316.

In the example of FIGS. 1 and 2, P_{S} denotes the projector 114, which projects the image 122 and the control buttons to have the fixed pose on the surface 124. In the example of FIGS. 5 and 6, C_{S} denotes the camera whose captured images (with additional digital content superimposed thereon) are displayed by the screen of the display device 310.

At a step 702, the processor 302 sets i=1. At a next step 704, the processor 302 causes Cᵢ to view a scene, capture and digitize images of such views, and output those images to the processor 302. Further, at the step 704, the processor 302: (a) receives those images from Cᵢ; and (b) detects and tracks visual features in a sequence of those images, without requiring a priori knowledge of those features or their locations. At a next step 706, the processor 302 determines whether a quality and number of those tracked features are sufficient (e.g., relative to predetermined thresholds for consistent distribution of features within an image, and consistent locations of features between multiple images).

In response to determining that the quality and number of those tracked features are insufficient, the operation continues from the step 706 to a step 708. At the step 708, the processor 302: (a) increments i=i+1; and (b) if such incremented i is greater than n, then resets i=1. After the step 708, the operation returns to the step 704.

Conversely, in response to determining that the quality and number of those tracked features are sufficient (e.g., better sufficiency than tracked features in images from other one(s) of the camera(s) 318), the operation continues from the step 706 to a step 710. At the step 710, in response to those tracked features from Cᵢ, the processor 302 performs a computer vision operation for estimating (e.g., computing) the pose of Cᵢ per image received from Cᵢ. For example, if the pose of Cᵢ is described by a rotation matrix Rᵢ (which describes how Cᵢ is rotated with three (3) degrees of freedom in the fixed world x-y-z coordinate frame) and a translation vector tᵢ (which describes how Cᵢ is translated with three (3) degrees of freedom in such coordinate frame), then pose of Cᵢ=[Rᵢ|tᵢ] which has a total six (6) degrees of freedom in such coordinate frame.

At a next step 712, the processor 302 determines whether P_{S} is then-currently projecting an image (and, optionally, additional digital content superimposed thereon) to have a fixed pose on a surface, as discussed hereinabove in the example of FIGS. 1 and 2. In response to determining that P_{S} is then-currently projecting such image, the operation continues from the step 712 to a step 714. At the step 714, in response to the pose of Cᵢ, the processor 302 computes the pose of P_{S}. For example, if respective directions of the arrows 104, 108, 112 and 116 are fixed in relation to the system 100 and one another, and if a transformation between respective poses of Cᵢ and P_{S} is denoted as T_{Ci}^{PS}, then the pose of P_{S}=T_{Ci}^{PS} • (pose of Cᵢ)=T_{Ci}^{PS} • [Rᵢ|tᵢ]. In one implementation, T_{Ci}^{PS} varies in response to a ratio between: (a) an estimated distance (e.g., received by the system 100 from the user) from P_{S} to the surface onto which P_{S} projects; and (b) an estimated distance (e.g., received by the system 100 from the user) from Cᵢ to the surface that Cᵢ views (e.g., on which its tracked features exist). After the step 714, the operation continues to a step 716.

Conversely, in response to determining that P_{S} is not then-currently projecting such image, the operation continues from the step 712 to a step 718. At the step 718, in response to the pose of Cᵢ, the processor 302 computes the pose of C_{S}, which denotes the camera whose captured images (with additional digital content superimposed thereon) are displayed by the screen of the display device 310 in the example of FIGS. 5 and 6. For example, if respective directions of the arrows 104, 108, 112 and 116 are fixed in relation to the system 100 and one another, and if a transformation between respective poses of Cᵢ and C_{S} is denoted as T_{Ci}^{CS}, then the pose of C_{S}=T_{Ci}^{CS} • (pose of Cᵢ)=T_{Ci}^{CS} • [Rᵢ|tᵢ]. In one implementation, T_{Ci}^{CS} varies in response to a ratio between: (a) an estimated distance (e.g., received by the system 100 from the user) from C_{S} to the surface that C_{S} views; and (b) an estimated distance from Cᵢ to the surface that Cᵢ views. After the step 718, the operation continues to the step 716.

At the step 716, the processor 302 computes image coordinates for displaying digital content to have a fixed pose in the fixed world x-y-z coordinate frame. Such digital content is either: (a) in the first mode of operation, an image (and, optionally, additional digital content superimposed thereon) for P_{S} to project on a surface, as discussed hereinabove in the example of FIGS. 1 and 2; or (b) in the second mode of operation, additional digital content for the screen of the display device 310 to display superimposed on a captured image from C_{S}, as discussed hereinabove in the example of FIGS. 5 and 6. In the first mode of operation, the processor 302 computes such image coordinates in response to the computed pose of P_{S}. In the second mode of operation, the processor 302 computes such image coordinates in response to the computed pose of C_{S}.

After the step 716, the operation continues to a step 720. At the step 720, the processor 302 causes either: (a) in the first mode of operation, P_{S} to project the image (and, optionally, additional digital content superimposed thereon) on the surface; or (b) in the second mode of operation, the screen of the display device 310 to display the additional digital content superimposed on the captured image from C_{S}. After the step 720, the operation returns to the step 704.

In one example, C_{S}=C₁, C₁ is the camera 102, C₂ is the camera 106, and the processor 302 determines that visual features (e.g., the features 128) detected and tracked in a sequence of images from C₂ have better sufficiency than visual features detected and tracked in a sequence of images from C₁. In such example, the processor 302: (a) in response to those tracked features from C₂, performs a computer vision operation for estimating the pose of C₂, in the fixed world x-y-z coordinate frame, per image received from C₂; (b) in response to the pose of C₂, computes the pose of C₁ in the fixed world x-y-z coordinate frame by applying a transformation T_{C2}^{C1} between those poses; (c) in response to the computed pose of C₁, computes image coordinates for displaying digital content to have a fixed pose in the fixed world x-y-z coordinate frame; and (d) causes the screen of the display device 310 to display such digital content superimposed on a captured image from C₁. If sufficient visual features exist on surface(s) in the field of view of the camera 102 and/or the camera 106, then the camera 110 is optional (e.g., if the camera 110 is removed from the system 100, then cost of the system 100 may be reduced).

In the illustrative embodiments, a computer program product is an article of manufacture that has: (a) a computer-readable medium; and (b) a computer-readable program that is stored on such medium. Such program is processable by an instruction execution apparatus (e.g., system or device) for causing the apparatus to perform various operations discussed hereinabove (e.g., discussed in connection with a block diagram). For example, in response to processing (e.g., executing) such program's instructions, the apparatus (e.g., programmable information handling system) performs various operations discussed hereinabove. Accordingly, such operations are computer-implemented.

Such program (e.g., software, firmware, and/or microcode) is written in one or more programming languages, such as: an object-oriented programming language (e.g., C++); a procedural programming language (e.g., C); and/or any suitable combination thereof. In a first example, the computer-readable medium is a computer-readable storage medium. In a second example, the computer-readable medium is a computer-readable signal medium.

A computer-readable storage medium includes any system, device and/or other non-transitory tangible apparatus (e.g., electronic, magnetic, optical, electromagnetic, infrared, semiconductor, and/or any suitable combination thereof) that is suitable for storing a program, so that such program is processable by an instruction execution apparatus for causing the apparatus to perform various operations discussed hereinabove. Examples of a computer-readable storage medium include, but are not limited to: an electrical connection having one or more wires; a portable computer diskette; a hard disk; a random access memory (“RAM”); a read-only memory (“ROM”); an erasable programmable read-only memory (“EPROM” or flash memory); an optical fiber; a portable compact disc read-only memory (“CD-ROM”); an optical storage device; a magnetic storage device; and/or any suitable combination thereof.

A computer-readable signal medium includes any computer-readable medium (other than a computer-readable storage medium) that is suitable for communicating (e.g., propagating or transmitting) a program, so that such program is processable by an instruction execution apparatus for causing the apparatus to perform various operations discussed hereinabove. In one example, a computer-readable signal medium includes a data signal having computer-readable program code embodied therein (e.g., in baseband or as part of a carrier wave), which is communicated (e.g., electronically, electromagnetically, and/or optically) via wireline, wireless, optical fiber cable, and/or any suitable combination thereof.

Although illustrative embodiments have been shown and described by way of example, a wide range of alternative embodiments is possible within the scope of the foregoing disclosure.

What is claimed is:

1. A method of superimposing content to have a fixed pose, the method comprising:
capturing first images of first views with a first camera;
displaying the first images on a screen of a display device;
capturing second images of second views with a second camera;
detecting and tracking visual features in the second images;
estimating a pose of the second camera in response to the tracked visual features; and
on the first images on the screen, superimposing the content to have the fixed pose in response to the estimated pose of the second camera.

2. The method of claim 1, wherein detecting and tracking the visual features includes performing a computer vision operation for detecting and tracking the visual features.

3. The method of claim 1, wherein the fixed pose is fixed in relation to a fixed world x-y-z coordinate frame.

4. The method of claim 1, wherein the first camera points in a first direction, and the second camera points in a second direction.

5. The method of claim 4, wherein the first and second cameras are fixed in relation to one another.

6. The method of claim 4, wherein the first direction is substantially orthogonal to the second direction.

7. The method of claim 4, wherein the first direction is substantially opposite the second direction.

8. The method of claim 1, wherein displaying the first images on the screen includes displaying the first images on a touchscreen.

9. A system for superimposing content to have a fixed pose, the system comprising:
a first camera for capturing first images of first views;
a display device for displaying the first images on a screen of the display device;
a second camera for capturing second images of second views;
at least one device for: detecting and tracking visual features in the second images; estimating a pose of the second camera in response to the tracked visual features; and, on the first images on the screen, superimposing the content to have the fixed pose in response to the estimated pose of the second camera.

10. The system of claim 9, wherein detecting and tracking the visual features includes performing a computer vision operation for detecting and tracking the visual features.

11. The system of claim 9, wherein the fixed pose is fixed in relation to a fixed world x-y-z coordinate frame.

12. The system of claim 9, wherein the first camera points in a first direction, and the second camera points in a second direction.

13. The system of claim 12, wherein the first and second cameras are fixed in relation to one another.

14. The system of claim 12, wherein the first direction is substantially orthogonal to the second direction.

15. The system of claim 12, wherein the first direction is substantially opposite the second direction.

16. The system of claim 9, wherein the screen is a touchscreen.

17. A system for superimposing content to have a fixed pose in relation to a fixed world x-y-z coordinate frame, the system comprising:
a first camera that points in a first direction for capturing first images of first views;
a display device for displaying the first images on a screen of the display device;
a second camera that points in a second direction for capturing second images of second views;
at least one device for: performing a computer vision operation for detecting and tracking visual features in the second images; estimating a pose of the second camera in response to the tracked visual features; and, on the first images on the screen, superimposing the content to have the fixed pose in response to the estimated pose of the second camera.

18. The system of claim 17, wherein the first and second cameras are fixed in relation to one another.

19. The system of claim 17, wherein the first direction is substantially orthogonal to the second direction.

20. The system of claim 17, wherein the first direction is substantially opposite the second direction.
